(19) United States
(12) Patent Application Publication
(10) Pub. No.: US 2016/0217479 A1
(43) Pub. Date: Jul. 28, 2016

(54) METHOD AND SYSTEM FOR AUTOMATICALLY RECOMMENDING BUSINESS PROSPECTS

(71) Applicants: AJAY KASHYAP, ROORKEE (IN); sANDEEP GURUVINDAPALLI, VATTIGUDIPADU (IN); vivek RAVINDRAN, singapore (SG)

(72) Inventors: AJAY KASHYAP, ROORKEE (IN); sANDEEP GURUVINDAPALLI, VATTIGUDIPADU (IN); vivek RAVINDRAN, singapore (SG)

(21) Appl. No.: 14/613,361

(22) Filed: Feb. 4, 2015

(30) Foreign Application Priority Data
Jan. 28, 2015 (SG) 10201500683T

(51) Int. Cl. G06Q 30/02; G06N 99/00; G06F 17/30; G06N 7/00

(52) U.S. Cl. CPC G06Q 30/0202; G06N 7/00; G06N 99/005; G06F 17/3053; G06F 17/30864

(57) ABSTRACT

Methods and systems for recommending limited, personalized and relevant list of prospects to enterprises, in a configurable, automated, scalable and machine-learnt way. According to one embodiment, raw data about potential prospects across diverse areas is collected from various data sources. The raw data is transformed to variables containing values in a binary format, also known as interests, in accordance with a predetermined set of rules. An interest graph is created with the interests as nodes and affinity between them as edges and net affinities are calculated and stored in an interest table. The user's requirements are understood through user input and a set of user-relevant interests is captured and extended with additional similar interests from the interest table. Multiple scores are calculated for each of the potential prospects based on this set of interests. A net score for each potential prospect is calculated and highest potential prospects are finally recommended.

### FIELD OF THE INVENTION

The present invention relates to a recommender system and a method of generating computer-implemented recommendations. More specifically, the invention relates to information filtering and recommending limited, personalized and relevant list of prospects to enterprises in real-time.

### BACKGROUND OF THE INVENTION

The internet age has information in abundance, and the biggest challenge faced by most users/customers is the explosion of choices due to more and varied sources of information, higher number of devices, increase in real-time data, higher transparency and the rise of social media.

With so much information at their disposal, organizations are envisioning a favorable opportunity to take business decisions backed by statistics and data. However, statistics and data alone can lead to a high number of choices or recommendations, and organizations must select the most relevant recommendations among them in order to take most favorable business decisions. This is not easy, may lead to more confusion leading to a decision paralysis and hence a reliable recommendation system that aims to alleviate decision paralysis is the need of the hour.

A recommendation service is a computer-implemented service that recommends choices from a database of information. The recommendations are customized to particular items based on information known about them. Recommender systems that provide recommendation service assist customers in selecting choices based on data related to purchases, reviews, browser cookies, likes on social media, common features or similarities between entities etc. From business perspective, recommender systems assist sales teams, marketing teams or public relations teams by providing personalized and relevant choices or recommendations.

The domain of recommender systems covers the steps of prediction and recommendation and leverages different mathematical methods to solve the problems of finding similarity and ranking in the choices presented to the organizations. The usage of such recommended choices is driven by both the objective methods (usefulness) and subjective perception (desirability).

The efficiency of the objective methods is based on the algorithms used to determine the choices, and there are two main methods to drive recommendations to the organizations—Collaborative Filtering and Content-based Filtering.

Collaborative Filtering measures a degree of affinity between various entities based on their actions such as buying behaviors, ratings. etc. Content-based Filtering uses relevant attributes to drive similarity between the two entities. There has been considerable research on recommendation systems using such methodologies. However, such recommendations offer only limited benefits and are not very useful under lot of differing circumstances.

Current recommender systems for business applications face issues such as lack of data due to limitations associated with availability, cost or location. Attribute-based recommender systems (described under the context of content-based filtering) recommend prospects that have attributes in common with the data input by the user. These recommender systems fail to provide an exhaustive list of choices with attributes similar to those derived from the user input. There have been some efforts to alleviate the mentioned issues. However, all of them do not address the problem in its entirety and, hence, overlook the underlying advantages.

U.S. Pat. No. 8,224,835 discloses a method of adding additional variables similar to the variables determined from user profile and input. The expansion of variables is done based on measure of co-occurrence of the variables and enables a more exhaustive search. However, this method fails to calculate degrees of co-occurrence or similarity between variables that are not directly connected. Moreover, the patent is focused on prediction rather than recommendation.

There have been some efforts focused on finding out strengths between indirectly connected nodes in the graph using flow-based analogous systems such as hydraulic analogous systems and electrical analogous systems, however they have not been applied in the context of recommendation systems yet. For instance, a paper titled ‘Electricity Based External Similarity of Categorical Attributes’ by Christopher Palmer, and Christos Faloutsos discloses attribute-to-attribute graphs along with electrical analogy for graph traversal by replacing edges with effective resistance. The algorithm is designed for effective study of graph traversal for capturing similarity between indirect attributes. However, neither does the research disclose any form of extrapolation for sparse data nor does it discuss the context of recommendation systems.

U.S. Pat. No. 8,355,896 discloses a variable-to-variable mapping using cooperating strength between the nodes, i.e. variables in the graph. Variables are identified from the raw data, and variable pairs are mapped using variables as nodes and cooperative strength as links between them. Variable pair with the highest strength is then chosen. The patent however fails to solve issues related to scarcity of raw data. Also, it does not take into account additional variables to conduct a more exhaustive search. Further, the method is not especially designed for recommendation purposes.

Similarly, there has been research on various kinds of graph-based data visualizations and flow techniques. However, so far, this research has not been able to place big data and recommendation systems in context For instance, ‘Handbook of Data Visualization’ by Chun-houh Chen, Wolfgang Karl Härdle, and Antony Unwin introduces different visualization techniques, and WO2001016805 proposes strength calculations.

Thus, there exists a reed for an improved recommender system for recommending exhaustive, relevant and personalized business prospects to users without being limited by issues such as scarcity of available data.

### SUMMARY OF THE INVENTION

The present invention provides a configurable, scalable, automated and machine-learnt method, system and software for recommending personalized, limited and relevant prospects to enterprises in real time.

In accordance with methods and systems disclosed in the present invention, raw data related to various prospects is obtained from multiple sources of data. The prospects could be potential customers, sales leads or business partners in the form of companies or organizations. The number of total prospects may not be limited. The raw data could include but may not be limited to the company profile, company financials, company hiring data, company news and social media data related to the company for all prospects. This raw data is then converted into structured data using a set of variables. The set of variables for structuring the raw data could be predetermined by the recommender system in accordance with the present invention. These variables could correspond to attributes of the prospects, including but not limited to technology domain of operation, products manufactured, locations of operation, number of employees, services bought by prospects, etc. Structuring the raw data implies determining the attributes of each prospect from the raw data using the predefined set of variables. The attributes thus determined are transformed into true/false format, which means that they take one of the two values in binary format. These attributes are known as “interests”. Once the interests for each prospect are determined, an interest graph is created from these interests. The interest graph comprises of the interests as nodes and the edges between the nodes as affinity between the interests. Affinity between any two nodes in the graph is calculated by implementing a net affinity algorithm. In accordance with the net affinity algorithm, an electrical circuit analogy is drawn for the interest graph by considering affinity between two nodes as respective conductance in the edge between the two nodes in the electrical circuit. Equivalent conductance between any two pairs of nodes is then interpreted as the net affinity between them. These net affinity scores are then exported to an interest table.

User input in form of current clientele, prioritization filters is received and a set of interests relevant to the user is determined for the user input. Additional interests from the interest table are included to extend the set of interests relevant to the user. Scores are now determined for each prospect using this extended set of interests and prospects are recommended to the user in decreasing order of scores.

### BRIEF DESCRIPTION OF THE DRAWINGS

FIG. 1 discloses a flow chart of steps performed in accordance with prior art methods for recommendations to users.

FIG. 2 is a flow chart of the steps performed in accordance with the present invention.

FIG. 3 depicts a data processing system for practicing methods and systems for implementing the present invention.

FIG. 4 illustrates interest graph in accordance an aspect of the present invention.

FIG. 5 illustrates net affinity calculation algorithm in accordance with the present invention.

FIG. 6 illustrates details of net affinity score calculation in accordance with the present invention.

FIG. 7 is a representation for explaining the components and steps of execution in the data processing system in accordance with an embodiment of the present invention.

### DETAILED DESCRIPTION OF THE INVENTION

Described herein are the methods, computer systems and software for recommending business prospects to enterprise customers in accordance with the present invention. The following detailed description of the invention refers to the accompanying drawings.

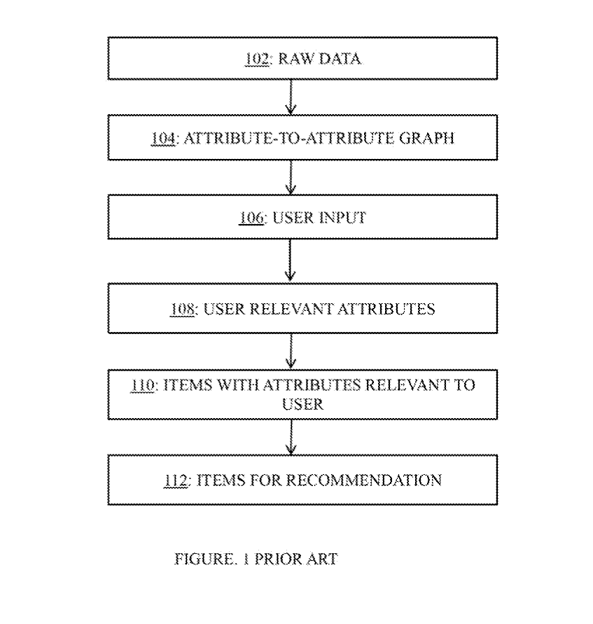

FIG. 1 shows a flow diagram in accordance with attribute-based recommender systems disclosed in the prior art. The flow diagram illustrates the key steps executed by these recommender systems for recommending choices to customers. At step 102, raw data related to items to be recommended such as products, prospects, movies, music etc. is received by the recommender system. At step 104, attributes corresponding to these items are determined and an attribute-to-attribute graph is then generated with attributes as nodes and proximity, i.e. similarity/co-occurrence between attributes as edges. At 106, user input is received which could be in form of user profile, preferences, clientele data etc. At step 108, attributes relevant to the user are determined using this input. At step 110, items with attributes similar to the attributes relevant to the user are determined. At step 112, the items thus determined are provided to the user in form of recommended items.

Thus, the prior art recommender systems do not provide exhaustive search by including additional attributes along with attributes identified from user input. Further, these systems are limited by the scarcity of raw data and do not calculate proximity between all pairs of attributes. In cases when sufficient raw data is not available for calculating proximity between all pairs of attributes, these systems would fail to generate a complete attribute-to-attribute graph and provide recommendations accordingly.

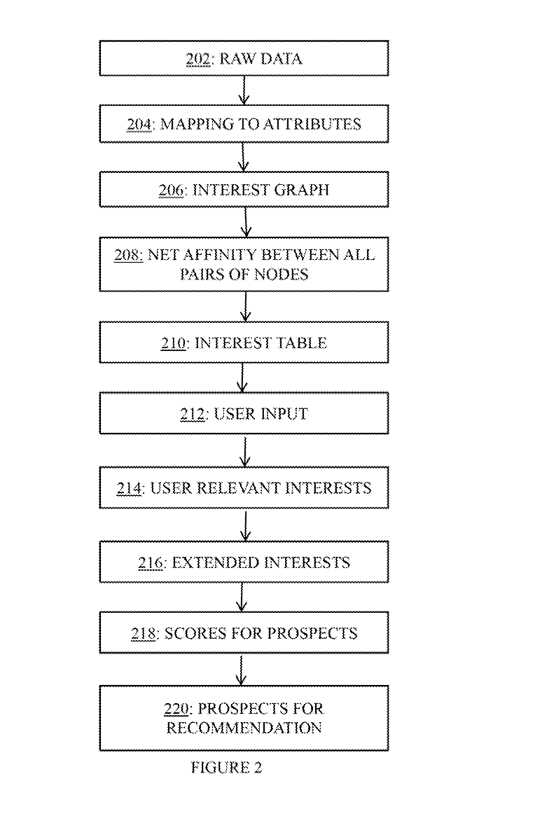

The current invention aims to solve the above-described underlying problems. FIG. 2 discloses a flow diagram in accordance with various steps executed by the method and system in accordance with the present invention. At step 202, raw data corresponding to potential prospects is collected. The prospects could be potential customers, sales leads or business partners in form of companies or organizations. At step 204, the raw data is structured by determining the attributes for each of the prospects. A set of variables predetermined by the recommender system is used for structuring the raw data. These variables could correspond to attributes of the prospects, including but not limited to technology domain of operation, products manufactured, locations of operation, number of employees, services bought by prospects etc. Structuring the raw data implies determining the attributes of each prospect from the raw data using the predefined set of variables. The attributes thus determined are transformed into true/false format, which means that they take one of the two values in binary format. These attributes are known as “interests”. At step 206, an interest graph is generated with interests as nodes and corresponding affinity between them as edges. The affinity between two interests in the graph is determined by the number of prospects for which values of both attributes is true. Now, at step 208, net affinity score is calculated for each pair of interests. The net affinity score calculation overcomes limitations of availability of data due to various factors and calculates affinity between all pairs of interests, using the affinities determined from the raw data. The net affinity is calculated using electrical circuit analogy for the interest graph. At step 210, an interest table is generated that discloses affinity score between each pair of interests. Now, user input in form of current clientele, prioritizing filters is received at step 212. At 214, a set of interests relevant to the user is determined using the user input, by determining the interests of the current clientele input by the user along with prioritizing filters selected by the user. At step 216, additional interests that have close affinity with interests relevant to the user are determined from the interest table. The additional interests thus determined are added to the set of interests relevant to the user. At step 218, this set of relevant interests is used to determine scores of each of the potential prospects. The prospects that possess a number of interests in common with the set of relevant interests get higher value of scores. A list of recommended prospects is then provided to the user at step 220 by listing the prospects in decreasing order of scores.

Thus, the present invention provides improvement over the prior art recommendation systems in a number of ways. It calculates affinities between all pairs of interest, irrespective of lack of availability of raw data for all prospects, by using the net affinity algorithm based on electrical circuit topology for interest graph. The invention also provides an exhaustive list of relevant interests by adding additional interests using the interest table. The extension of relevant interests from interest table ensures a more exhaustive and effective search for prospects relevant to the user and removes limitations on user input in thrill of current clientele. Thus, the user can provide input of as low as one current client and yet get better recommendations for prospects using the present invention. The present invention thus removes limitations due to lack of availability of raw data on prospects and provides better recommendations to users by further including additional similar interests in addition to relevant interests identified from the user input.

It is to be noted that the term ‘raw data’ is limited in its context to the invention and may simply mean ‘unprocessed data’, wherein the data is processed such that it can be used directly by the recommender system.

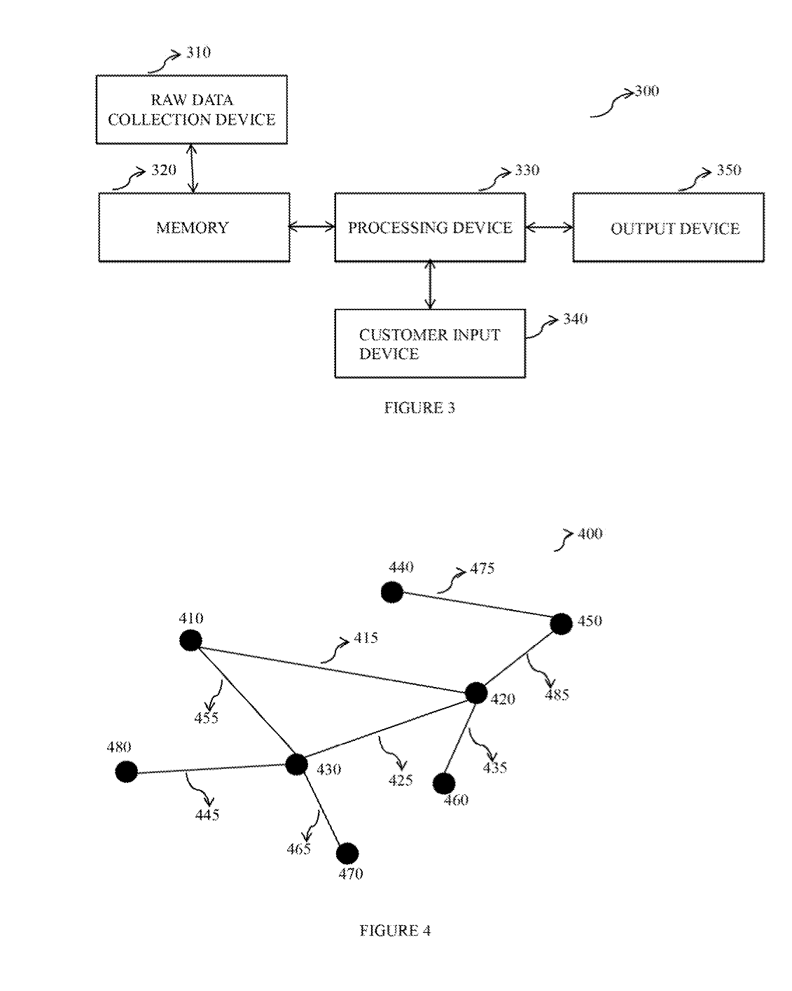

FIG. 3 depicts a block diagram of a recommender system 300 in accordance with one embodiment of the present invention. The system 300 comprises a raw data collection device 310 which collects raw data including, but not limited to company profile, company financials, company hiring data, company news and social media data related to company for all prospects. The raw data collection device 310 could be a computer, central processing unit (CPU), processor, and/or a microprocessor, controller enabled with memory or a combination of these. The raw data collection device 310 could further include software or programmed code for enabling raw data collection. Further, the raw data collection device 310 could be connected to a communication network including, but not limited to Internet, Ethernet, Local Area Network (LAN), and Wide Area Network (WAN). The raw data collection device 310 is coupled to memory device 320. The raw data collected by the raw data collection device 310 is stored in the memory 320. The received raw data could be stored in a structured or non-structured format in memory 320. The memory 320 could further store algorithm for receiving data, processing data, set of attributes for data, feedbacks received from the user, user input data, past recommendation results. The memory 320 could be a RAM, ROM, hard disk, server or any other storage memory known in the art. The processing device 330 is coupled to the memory 320 and receives the raw data stored in the memory. The processing device 330 could be a computer, server, processor, CPU, or a combination thereof, enabled with software for implementing the algorithm in accordance with the present invention. After receiving the raw data from memory 320, the processing device 330 converts this raw data into structured data using a set of variables. This set of variables could be predefined or automatically determined by the system. The total number of variables in this set of variables may not be limited. Attributes of each prospect are determined using this set of variables. The processing device 330 then transforms the attributes in true/false format such that each attribute takes only one of two values in binary format and these attributes are known as interests. The processing device 330 further creates interest graph from these interests as nodes and affinity between them as edges. The processing device 330 calculates affinity between two interests by calculating the total number of prospects for which value of both interests is true. The processing device 330 further calculates net affinity score between any two interests in the interest graph using a net affinity algorithm. Customer input device 340 enables the customer to include data, including but not limited to current clientele, prioritizing filters for interests and feedback on recommendation results. The customer input device 340 could be a computer, portable computer such as laptop, mobile handset, personal data assistant such as tablet. The customer input device 340 could further be enabled with software for assisting input of data by the customer. The processing device 330 identifies a set of interests relevant to the customer using this input. The processing device 330 further extends the set of relevant interests by including additional interests from the interest table. The processing device 330 then uses this extended set of relevant interests to calculate scores for all prospects. A list of recommended prospects is then determined by the processing device 330, in decreasing order of values of scores. This list of recommended prospects is then provided to the output device 350 for display to the customer. The output device 350 could be display device such as computer, portable computer such as laptop, mobile handset, personal data assistant such as tablet. In many cases, the customer input device may be the same as the customer output device.

According to embodiments of the present invention, the prospects could be potential customers, sales leads or business partners in form of companies or organizations. Further, the raw data could be obtained by the raw data collection device 310 from external or internal sources including, but not limited to database of directories, company websites, public data about companies, financial information from partnerships, job portals, global news about companies, data based on the social media such as Facebook, Twitter, LinkedIn etc. Further, the raw data could belong to categories such as Social Media, Purchase receipts, Cookie data associated with browsing behaviors, Loyalty data, Credit card data, Customer reviews etc.

According to one aspect of the present invention, the raw data received is structured using a set of variables by the processing device 330. The variables could be predefined or could be automatically determined by the system. Structuring the raw data implies determining the attributes of each prospect from the raw data using the predefined set of variables. These variables could correspond to attributes of the prospects, including but not limited to technology domain of operation, products manufactured, locations of operation, number of employees, services bought by prospects etc. The transformation of raw data to attributes of prospects enables the recommendation system and algorithm to process the data effectively. The processing device 330 identifies the attributes of each prospect using the raw data. The attributes of prospects are known as “interest” in accordance with the present invention. The interests can take either true or false value, i.e. for all prospects, the value of each interest is determined to be either true or false, depending on the raw data. The true and false values may be stored in binary format with true denoted as 1 and false denoted as 0. The affinity between two interests is identified by the number of prospects that possess both the interests. Thus, transforming the raw or unprocessed data to attributes is a significant part of the system to enable further processing of raw data.

After the affinities between interests are determined, the interests and their corresponding affinities are mapped to an interest graph. FIG. 4 illustrates interest graph 400 in accordance with an aspect of the present invention. Interests are marked as nodes 410, 420, 430, 440, 450, 460, 470, 480 in the interest graph 400. The affinity between respective nodes is represented by edges, 415, 425, 435, 445, 455, 465, 475. For example, affinity between interests represented by nodes 410 and 420 is represented as edge 415 between these two nodes.

Affinity between two interests is affected by the number of prospects possessing both the interests. Affinity between two interests could also depend on factors such as availability of raw data, location, cost etc. For example, the affinity between two interests might be higher but due to lack of availability of raw data for associating the two interests, the affinity between these interests may not be reflected by the raw data. In order to take these factors into account, the system calculates a net affinity score between any two nodes in the interest graph. Thus, the net affinity algorithm takes into account direct as well as indirect affinity between the two nodes and calculates a net affinity between all pairs of nodes in the interest graph.

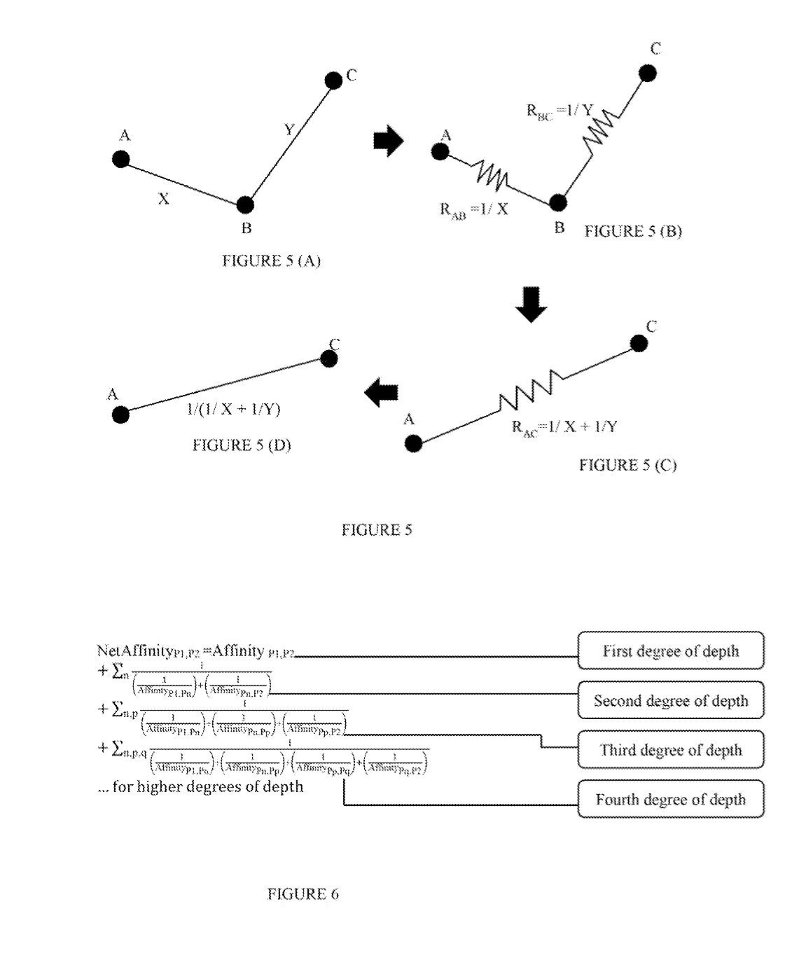

FIG. 5 illustrates net affinity algorithm in accordance with the present invention. The net affinity algorithm implements the electrical circuit analogy in the interest graph. It simulates the interest graph by simulating the edges between nodes as resistance in the electrical circuit. This implies that the affinity between the nodes is estimated as the strength of conductivity between the two nodes. FIG. 5(A) illustrates an affinity graph with nodes A, B and C. Affinity between nodes A and B is x and affinity between nodes B and C is y. There is no direct affinity between nodes A and C. This means that the raw data does not provide any information to calculate affinity between interests A and C. However, the nodes A and C could be indirectly associated through intermediate node B. As shown in FIG. 5(B), in accordance with electrical circuit analogy for the interest graph, the affinity x between nodes A and B is represented as resistance of measure 1/x. Similarly, affinity between B and C is represented as resistance of measure 1/y. Now, effective resistance between nodes A and C can be calculated to be equal to (1/x+1/y), as shown in FIG. 5(C), according to electrical circuit topology. The effective resistance between nodes A and C represents net affinity 1/(1/x+1/y), between the nodes A and C, as shown in FIG. 5(D). Similarly, net affinity is calculated between all pairs of nodes in the interest graph. The analysis could be one degree or two degree or higher degree depending on the number of intermediate nodes between the two nodes. This net affinity is known as net affinity score between the pairs of nodes.

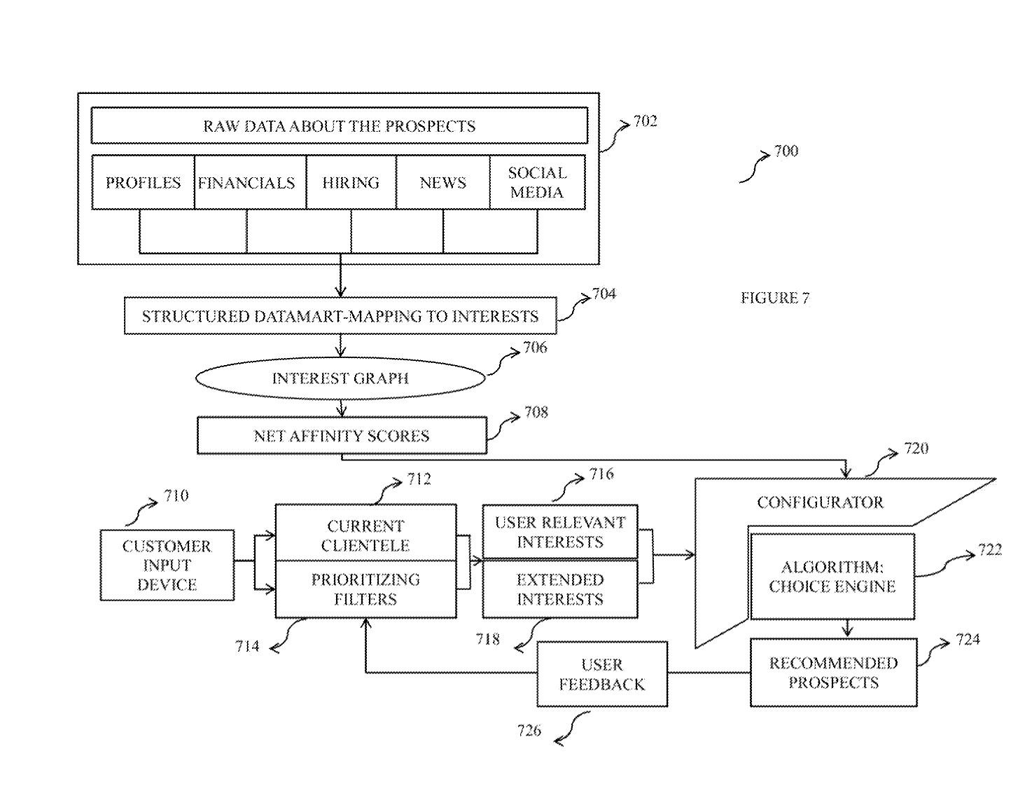

FIG. 6 further describes the net affinity calculation in accordance with the present invention. The interest graph may contain various nodes ‘P₁’, ‘P₂’, ‘Pᵤ’, ‘Pₚ’ and ‘P_{q}’ and nodes ‘P₁’ and ‘P₂’ are connected with each other directly, via the node ‘Pᵤ’, via the node ‘Pₚ’ and via the node ‘P_{q}’. The nodes ‘P₁’, ‘P₂’, ‘Pₙ’, ‘Pₚ’ and ‘P_{q}’ may represent the interests and the connections between any two nodes may represent the affinity value, respectively. The net affinity between the two interests i.e. nodes ‘P₁’ and ‘P₂’ may be calculated with various degrees of depth as follows:

The net affinity between the nodes ‘P₁’ and ‘P₂’ (which are connected to each other directly i.e. a first degree of depth) may be calculated using the following formula, as shown in FIG. 6:

NetAffinity_{P1, P2}=Affinity_{P1, P2}

The net affinity between the nodes ‘P₁’ and ‘P₂’ (which are connected via node ‘Pₙ’ i.e. a second degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )} ,$$

wherein n represents the number of nodes present in the interest graph and ‘Pᵤ’ represents n^{th} node in the interest graph.

The net affinity between the nodes ‘P₁’ and (which are connected via the node ‘Pᵤ’ and a node ‘Pₚ’ i.e. a third degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )} + {\sum }_{n , p} \frac{1}{( \frac{1}{{Affinity}_{P 1 , Pn}} ) + ( \frac{1}{{Affinity}_{Pn , {P}_{p}}} ) + ( \frac{1}{{Affinity}_{{P}_{p} , P 2}} )}$$

wherein ‘Pₚ’ represents a first intermediate node.

The net affinity between the nodes ‘P₁’ and ‘P₂’ (which are connected via the node ‘Pₙ’, the node ‘Pₚ’ and a node ‘P_{q}’ i.e. a fourth degree of depth) may be calculated using the following formula, as shown in FIG. 6:

$${NetAffinity}_{P 1 , P 2} = {Affinity}_{P 1 , P 2} + {\sum }_{n} \frac{1}{( \frac{1}{{Affinity}_{P 1 , Pn}} ) + ( \frac{1}{{Affinity}_{Pn , P 2}} )} + {\sum }_{n , p} \frac{1}{( \frac{1}{{Affinity}_{P 1 , Pn}} ) + ( \frac{1}{{Affinity}_{Pn , {P}_{p}}} ) + ( \frac{1}{{Affinity}_{{P}_{p} , P 2}} )} + {\sum }_{n , p , q} \frac{1}{\begin{matrix}( \frac{1}{{Affinity}_{P 1 , Pn}} ) + ( \frac{1}{{Affinity}_{Pn , {P}_{p}}} ) + \\ ( \frac{1}{{Affinity}_{{P}_{p} , {P}_{q}}} ) + ( \frac{1}{{Affinity}_{{P}_{q} , P 2}} )\end{matrix}}$$

wherein ‘P_{q}’ represents a second intermediate node.

According to another aspect of the invention, the net affinity scores determined using the net affinity algorithm are exported to an interest table. The interest table illustrates net affinity scores between two attributes in a tabular format. Following is an example of interest table with a three interests in accordance with the invention:

TABLE 1

| Interest | | |
|---|---|---|
| 1 | Interest 2 | Net affinity score between Interest 1 and Interest 2 |
| A | B | 15 |
| B | C | 25 |
| A | C | 20 |

Table 1 illustrates net affinity scores between pairs of attributes. For example, net affinity score between attribute A and B is 15.

According to another aspect of the invention, user input is taken from the customer. The Customer input device 340 in FIG. 3 receives the user input. The user input could include, but not limited to current clientele data of the enterprise, prioritizing filters selected by the user, feedback on recommendations delivered by the system. The customer data comprising current clientele data could be manually input by the user using software application on mobile handset, computer, tablet or Personal Data Assistance (PDA) or could be sent via email, uploading to server etc. The customer data could also be obtained directly from software such as Customer Relationship Management (CRM) software of the enterprise. The user could provide clientele data for any number of current clients, without any limit on minimum or maximum number of clients. The user could further be required to select prioritizing filters for configuring the output recommendations. The prioritizing filters could enable the user to select certain attributes for the searching of relevant prospects by the system. Further, the prioritizing filters could also enable the user to select weights to various attributes or categories of attributes for configuring the search of relevant prospects by the system. User input is required by the system for identifying a first set of attributes relevant to the customer. After receiving the user input, a set of interests relevant to the customer is identified. For example, current clientele data input by the user would disclose the interests possessed by the current clients of the customer. Further, prioritizing filters selected by the user would help the user to customize the search of recommended prospects.

The set of interests relevant to the customer is extended by using the interest table. This implies that, additional interests are identified from the interest table that could potentially be relevant to the user but are not disclosed by the set of interests identified from user input. For example, referring to Table 1, if interest A is identified as an interest relevant to the user through the user input, interest C would also be added to the set of interests relevant to the user, because net affinity score between A and C is high in value. Similarly, other additional interests would be identified from the interest table by using the net affinity score between the interests in the interest table. A minimum value of net affinity score could be used as a threshold for selecting the additional interests to be added to the set of interests relevant to the user. An extended set of interests relevant to the user is thus obtained. Inclusion of additional interests having a high affinity with the set of interests relevant to the user helps in making the search for potential prospects more exhaustive, by including more number of relevant interests. This improves the efficiency of recommendation and also provides better and exhaustive results to the customer by using a broader list of parameters for the search of potential prospects.

After the extended set of interests relevant to the customer is identified, scores are generated for each potential prospect. The scores are generated by identifying interests in common between the set of identified relevant interests and the interests possessed by the prospect. For example, if interests A, B are identified as relevant to the user, the system will search in the memory 320 for prospects that possess both or at least one of interests A and B. Further, value of score for each prospect could be determined by number relevant interests possessed by the prospect, along with weight of these interests, selected by the user or by the system. Hence, a list of potential prospects with associated scores is determined. The most relevant prospects would have higher scores than the other prospects because a higher value of the score implies that the prospect possesses number of relevant interests with higher weight. Thus, higher the score of prospect, more relevant the prospect is to the customer. The system could now provide a list of recommended prospects in decreasing order of relevance to the user through output device 350. There could be a threshold on the number of prospects to be delivered. Also, there could be a threshold on the value of the score of prospect to be selected for recommendation.

According to an embodiment, the present invention further consists of configurator for configuring various parameters such as weights for interests, scores for prospects or number of prospects to be recommended. FIG. 7 illustrates the embodiment of the present invention, 700 including configurator 722 and user feedback 726 in association with other parts of the present invention. After receiving raw data about the prospects in step 702, the interests for the prospects are determined in step 704 and interest graph is created at step 706, with interests as nodes and affinities between them as edges, according to the previously disclosed embodiments. Net affinity scores are determined at step 708, in accordance with net affinity algorithm disclosed by FIG. 6 and FIG. 7. Now, customer input device 710 is used to receive input from the user in form of current clientele 712 and prioritizing filters 714. Interests relevant to the user are determined at 716, and these interests are further extended using interest graph at 718. Now, configurator 720 could be enabled to select confidence level thresholds for interests determined from user input in form of current clientele data, and feedback on previous prospects, respectively. It could further configure weights for relevant interests determined from user inputs in form of prioritizing filters, current clientele data, and feedback on previous prospects, respectively. Configuring the weights for interests determined from each of these forms of user input enables optimum selection of more relevant prospects in accordance with the appropriate weights. The configurator 720 could further assign weights for relevant interests determined from user input at 716, and the additional relevant interests determined from interest table at 718, respectively, so that impact of the respective sets of interests on the selection of potential prospects can be varied to achieve better recommendations. The configurator 720 could assign weights for the scores generated for each of the potential prospects. Further, the configurator 720 could also configure the total number of prospects required for recommendation. The configurator 720 serves to customize the parameters and relevant interests for recommending better prospects to the customer. The respective parameters for configuration could be selected by the user or could be learned by the recommendation system in an automated manner. Now, the choice engine algorithm 722 calculates scores for each prospect, in accordance with the confrontation determined by the configurator 720. The prospects in decreasing order of values of scores are recommended to the user at 724. The number of prospects recommended to the user at step 724 is limited by the number of prospects for recommendation determined by the configurator 720. At step 726, the user provides feedback on the prospects recommended at step 724. The user feedback is then taken into consideration by the system 700 for recommending next set of prospects in future.

The system 700 learns automatically from the user feedback on past recommendations. The user could provide negative or positive feedback to the recommendation system depending on relevancy of the recommended prospects. When the system receives a positive feedback, it interprets that the set of interests used for determining the prospects was optimum and takes this set of interests into consideration for future recommendations to the user. On the other hand, when it receives a negative feedback, it re-examines the set of interests and modifies them so as to provide better recommendations in future to the user. Thus, the system 700 automatically learns to choose more relevant interests for recommendation depending on the user feedbacks.

The system is further capable of learning and improving its configuration automatically, without human intervention. The system is configured to be improvise itself by incorporating empirical data from various data sources and is configured to automatically learn to recognize complex patterns and make intelligent decisions based on the empirical data from various data sources. The empirical data sources could be the data sources based on customer feedbacks, logs resulting from usage of the proposed recommendation system or additional available user data in the existing data sources. The system is thus machine learned and learns automatically from the user feedbacks on recommendation results.

The recommendation system in accordance with the present invention does not have any limitations on maximum number of prospects or number of interests in the interest graph. The system does not require human intervention for collecting and storing raw data, mapping to interests, creating interest graph, expanding relevant interest or selecting the prospects for recommendation. Further, the system is configurable and learns from the user feedback automatically. The system is thus automatic, scalable, configurable and machine-learnt.

The embodiments in accordance with the present invention can be implemented with any combination of hardware and software. If implemented as a computer-implemented apparatus, the present invention is implemented using means for performing all of the steps and functions described above.

Although the description above illustrates the present invention with many specific examples, these should not be construed as limiting the scope of the invention but as merely illustrating some of the presently preferred embodiments of this invention. Thus, the scope of the invention should be determined by the appended claims and any and all equivalents thereof, rather than by the examples given. It should be understood that various changes and substitutions could be made herein without departing from the spirit and scope of the invention.

What is claimed as new and desired to be protected by Letters Patent of the United States is:

1. A method for recommending limited, personalized and relevant list of prospects to enterprises in real-time, the method comprising:
receiving data in relation to various potential prospects from various data sources;
transforming the received data into a set of variables known as interests;
generating an interest graph with interests as nodes and associated affinity between them as edges;
calculating a net affinity score between all pairs of interests in the interest graph;
exporting the interest graph with the net affinity scores to an interest table;
receiving user input and determining a set of interests relevant to user from the user input;
extending the set of interests relevant to the user by including additional interests from the interest table to obtain an extended set of relevant interests;
generating scores for each of the potential prospects based on the extended set of relevant interests; and
recommending the list of prospects based on descending order of values of the scores.

2. The method described in claim 1 is configurable, scalable and automated.

3. The method described in claim 1 is further machine learnt by being configured to be improved by incorporating empirical data from various data sources and is configured to automatically learn to recognize complex patterns and make intelligent decisions based on the empirical data from various data sources.

4. The method described in claim 1 is further configured to learn from user feedbacks, wherein the system automatically learns to choose more relevant interests for recommendation depending an the user feedbacks.

5. The method according to claim 1 wherein the interests can take binary values.

6. The method according to claim 1 wherein the user input is current clientele data, feedback on previous prospects and a prioritizing filter.

7. The method according to claim 1, further comprises configuring:
confidence level thresholds for interests determined from user input in form of current clientele data, and feedback on previous prospects, respectively;
weights for relevant interests determined from user inputs in form of prioritizing filters, current clientele data, and feedback on previous prospects, respectively;
weights for relevant interests determined from user input, and the additional relevant interests determined from interest table, respectively;
weights for the scores generated for each of the potential prospects; and
total number of prospects required.

8. The method described in claim 1, wherein affinity score between any two interests is determined b the number of prospects having both these interests in common.

9. The method described in claim 1, wherein the data is received in all possible formats, which may be raw or processed.

10. The method according to claim 1, wherein the received data from various data sources comprises of company profile, company financials, company hiring data, company news and social media data related to a company.

11. A system for recommending limited, personalized and relevant list of prospects to enterprises in real-time, the system comprising:
a data receiving device for receiving data in relation to various potential prospects from various data sources;
a user input receiving device for receiving at least one user input;
at least one processor coupled to a memory, the processor executes an algorithm for:
transforming the received data into a set of variables known as interests;
generating an interest graph with interests as nodes and associated affinity between them as edges;
calculating a net affinity score between all pairs of interests in the interest graph;
exporting the interest graph with the net affinity scores to an interest table;
determining a set of interests relevant to user from the user input;
extending the set of interests relevant to the user by including additional interests from the interest table to obtain an extended set of relevant interests;
generating scores for each of the potential prospects based on the extended set of relevant interests; and
selecting the list of prospects for recommendation based on descending order of values of the scores; and
an output device to display the list of prospects for recommendation to the user.

12. The system described in claim 11 is configurable, scalable and automated.

13. The system described in claim 11 is further machine learnt by being configured to be improved by incorporating empirical data from various data sources and is configured to automatically learn to recognize complex patterns and make intelligent decisions based on the empirical data from various data sources.

14. The system described in claim 11 is further configured to learn from user feedbacks, wherein the system automatically learns to choose more relevant interests for recommendation depending on the user feedbacks.

15. The system according to claim 11 wherein the interests can take binary values.

16. The system according to claim 11 wherein the user input is current clientele data, feedback on previous prospects and a prioritizing filter.

17. The system according to claim 11 further comprising a configurator for configuring:
confidence level thresholds for interests determined from user input in form of current clientele data, and feedback on previous prospects, respectively;
weights for relevant interests determined from user inputs in form of prioritizing filters, current clientele data, and feedback on previous prospects, respectively;
weights for relevant interests determined from user input, and the additional relevant interests determined from interest table, respectively;
weights for the scores generated for each of the potential prospects; and
total number of prospects required.

18. The system described in claim 11, wherein affinity score between any two interests is determined by the number of prospects having both these interests in common.

19. The system described in claim 11, wherein the data is received in all possible formats, which may be raw or processed.

20. The system according to claim 11, wherein the data received from various data sources comprises of company profile, company financials, company hiring data, company news and social media data related to a company.

21. A non-transitory computer medium configured to store executable program instructions, which, when executed by an apparatus, cause the apparatus to perform the steps of:
receiving data in relation to various potential prospects from various data sources;
transforming the received data into a set of variables known as interests;
generating an interest graph with interests as nodes and associated affinity between them as edges;
calculating a net affinity score between all pairs of interests in the interest graph;
exporting the interest graph with the net affinity scores to an interest table;
receiving user input and determining a set, of interests relevant to user from the user input;
extending the set of interests relevant to the user by including additional interests from the interest table to obtain an extended set of relevant interests;
generating scores for each of the potential prospects based on the extended set of relevant interests; and
recommending the list of prospects based on descending order of values of the scores.
